(19) United States
(12) Patent Application Publication
(10) Pub. No.: US 2013/0084167 A1
(43) Pub. Date: Apr. 4, 2013

(54) WEAR-RESISTANT COATING AND USE THEREOF

(71) Applicant: ROLLS-ROYCE PLC, London (GB)

(72) Inventors: Andrew HEWITT, Derby (GB); Matthew HANCOCK, Derby (GB)

(73) Assignee: ROLLS-ROYCE PLC, LONDON (GB)

(21) Appl. No.: 13/625,478

(22) Filed: Sep. 24, 2012

(30) Foreign Application Priority Data
Sep. 30, 2011 (GB) 1116829.1

(51) Int. Cl. F01D 11/08; C01F 7/02; C23C 4/10

(52) U.S. Cl. 415/173.1; 427/453; 423/600

(57) ABSTRACT

A rotor blade 2 for a gas turbine engine, comprising a blade tip 4. At least a portion of the blade tip 4 is provided with a wear-resistant coating 16, 18 comprising magnesium aluminate spinel.

This invention relates to use of magnesium aluminate spinel as a wear resistant coating, and is particularly, but not exclusively concerned with use of magnesium aluminate spinel as a wear resistant coating for at least a portion of a blade tip of a rotor blade of a gas turbine engine.

The efficiency of a turbine of a gas turbine engine is reduced by leakage of air through the gap between the tips of the turbine blades and the casing of the turbine. In order to combat these losses, the tip of each blade is often provided with a shroud. Shrouds of adjacent blades abut each other to form an annular surface which inhibits flow of air over the blade tips. In addition, each shroud is typically provided with one or more fins which extend outwardly of the shroud towards the casing. The fins seal against the casing in order to reduce losses over the top of the shroud. Nevertheless, in order to allow the rotor blades to rotate with respect to the casing a small gap remains between the fins and the casing. Reducing the size of this gap reduces the amount of air which leaks over the tips of the fins (known as fin tip losses) and so improves the efficiency of the turbine.

Constraints imposed by manufacturing capability and the ability to accurately predict blade and casing deformations during engine operation make it difficult to produce turbines having acceptable gaps between the fin tips and the casing. Casings are therefore often provided with abradable liners which, during operation of the turbine, are eroded by the fin tips. Because the amount of erosion is dependent on the amount of blade expansion or casing deformation, the amount of liner eroded is no more than that required for clearance of the fin tip. Consequently, the gap between the fin tips and the casing is minimised thereby improving the seal between the fin tip and the casing. This improves the efficiency of the turbine.

Typically, the fin tips are coated with a Zirconia or Alumina ceramic coating. These coatings prevent high temperatures being generated as the fin tips rub against the liner, thereby reducing the likelihood of melting or cracking of the fin tips. However, these coatings are known to wear quickly. As the coatings wear, the gap between the fin tips and the casing increases allowing more air to escape over the fin tips, reducing turbine efficiency. In addition, the coatings become less effective at preventing the fin tips from heating leading to an increase in the likelihood of cracking and consequent failure. Furthermore, coatings of Zirconia or Alumina are known to sinter and degrade at temperatures which are present in turbines of large turbofan engines. Therefore, such coatings are unsuitable for use in turbines of large turbofan engines.

Zirconia and Alumina ceramic coatings are also known to be difficult to apply to turbine blades on account of being particularly sensitive to contaminants, for example residues from previous coating processes which remain on the surfaces of the blades.

According to a first aspect of the present invention there is provided a rotor blade for a gas turbine engine, comprising a blade tip, at least a portion of the blade tip being provided with a wear-resistant coating comprising magnesium aluminate spinet.

The wear-resistant coating may be an abrasive coating. The wear-resistant coating may be an external coating. The wear-resistant coating may be a continuous coating.

A bond coating may be disposed between the wear-resistant coating and a substrate material of the rotor blade for bonding the wear-resistant coating to the substrate material.

The blade tip may be provided with a fin extending outwardly of the blade tip in the spanwise direction of the blade, the wear-resistant coating being provided on the fin. The blade tip may comprise a shroud, the fin being provided on the shroud.

The rotor blade may be a turbine blade.

According to a second aspect of the present invention there is provided a gas turbine engine comprising a casing and a rotor rotatable within the casing, the rotor carrying a plurality of rotor blades, at least one of the rotor blades being in accordance with the first aspect of the invention, wherein the casing comprises an abradable liner, the rotor blade being arranged such that rotation of the rotor with respect to the casing causes the portion of the blade tip having the wear-resistant coating to rub against the liner.

According to a third aspect of the present invention there is provided a method of coating a tip of a rotor blade for a gas turbine engine, wherein a wear-resistant coating comprising magnesium aluminate spinet is applied to at least a portion of the tip using a thermal spraying process.

The thermal spraying process may comprise a plasma spraying process or a high velocity oxygen fuel spraying process.

According to a fourth aspect of the present invention there is provided the use of magnesium aluminate spinel as a wear-resistant coating. The wear-resistant coating may be provided on at least a portion of a rotor blade for a gas turbine engine, for example the wear-resistant coating may be provided on a tip of the rotor blade.

For a better understanding of the present invention, and to show more clearly how it may be carried into effect, reference will now be made, by way of example, to the accompanying drawings, in which:

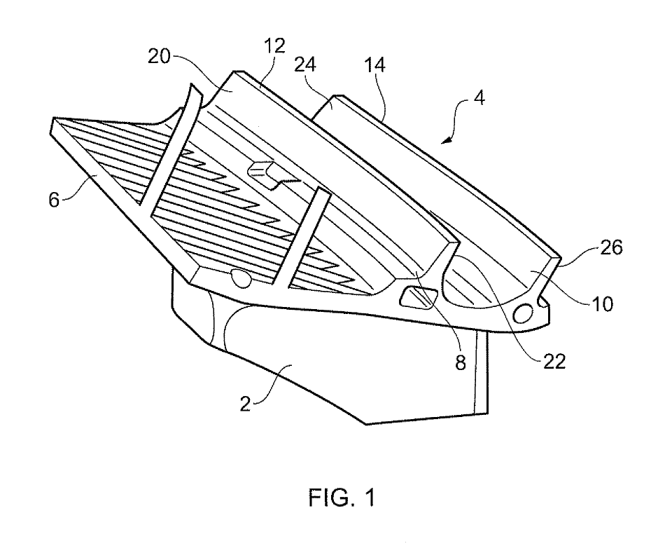

FIG. 1 is a partial perspective view of a rotor blade for a gas turbine engine; and

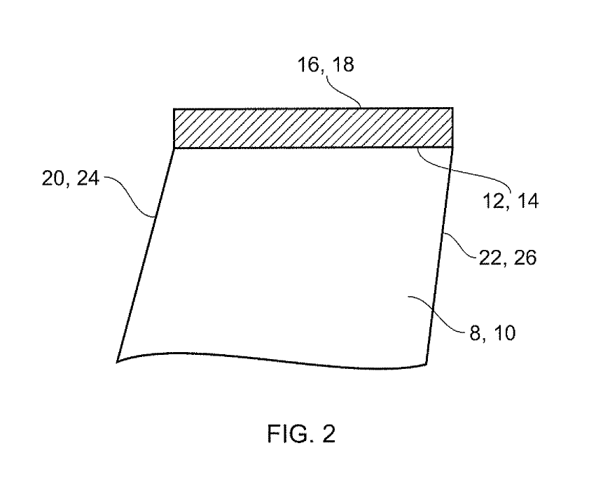

FIG. 2 is a schematic representation of a fin tip in section provided with a coating.

FIG. 1 is a partial view of a rotor blade 2 for a gas turbine engine in the region of the blade tip 4. The rotor blade 2 is a turbine blade for a gas turbine engine such as a turbofan used for propulsion of an aircraft. The blade tip 4 comprises a shroud 6. The shroud 6 is provided with two fins 8, 10 which extend outwardly of the blade tip 4. The fins 8, 10 span the circumferential width of the shroud 6 and are spaced apart from each other in the lengthwise direction of the shroud 6.

Each fin 8, 10 has a tip surface 12, 14 which extends along the tip of the fin 8, 10. FIG. 2 is a schematic representation of an end region of one of the fins 8, 10 viewed along the length of the fin 8, 10. For the purposes of this description, the end regions of the fins 8, 10 are the same. Each tip surface 12, 14 is provided with a wear-resistant coating 16, 18 comprising magnesium aluminate spinel. The wear-resistant coating 16, 18 forms a layer on the tip surface 12, 14 of the fin 8, 10. The layer is formed as an external abrasive layer. The coating 16, 18 is a continuous coating which is uninterrupted along the length of the fin 8, 10. The coating covers the entire tip surface 12, 14, and may cover upper portions of the sides 20, 22, 24, 26 of the fin 8, 10, which are adjacent the tip surface 12, 14.

The wear-resistant coating 16, 18 is applied to a substrate material of the rotor blade 2. The substrate material may be the material comprising the main body of the rotor blade 2, such as a high-temperature aerospace alloy, or an intermediate material deposited on the main body of the rotor blade 2. For example, the wear-resistant coating 16, 18 may be applied to an existing coating on each fin 8, 10 such as a thermally resistive coating, or a bond coating which improves adhesion of the wear-resistant coating to the blade 2.

The wear-resistant coating 16, 18 is applied to each fin 8, 10 using a thermal spraying process such as a plasma spraying process or a high velocity oxygen fuel spraying process. A thermal spraying process provides a coating which is particularly hard and bonded to the blade 2 such that the coating is capable of eroding liner material used on casings of gas turbine engines at high temperatures without significant degradation of the coating. The coating may also significantly increase the strength of each fin 8, 10.

The composition of the coating may be entirely magnesium aluminate spinel, although it is recognised that the coating 16, 18 may comprise trace amounts of impurities. Alternatively, the coating may comprise magnesium aluminate spinel in addition to other materials, the magnesium aluminate spinel being present in sufficient quantities to provide a wear-resistant coating.

A turbine (not shown) of a gas turbine engine comprises a plurality of rotor blades 2 as described above, which are arranged about a rotor. The rotor is disposed within a casing having an abradable liner such that the fins 8, 10 are disposed proximate the liner and define a gap between the wear-resistant coating 16, 18 on the tip surfaces 12, 14 and the abradable liner.

In use, the turbine is operated at temperatures in excess of 1300 degrees centigrade, and may be operated at temperatures in excess of 1400 degrees centigrade. These elevated temperatures, coupled with the large radial loads generated by rotation of the rotor blades 2, cause the blades 2 to expand radially. The expansion displaces the tips of the fins 8, 10 radially outwardly thereby bringing the wear-resistant coating 16, 18 on the tip surfaces 12, 14 into contact with the abradable liner. As the wear-resistant coating 16, 18 is rubbed along the abradable liner it erodes the liner thereby cutting a circumferential groove in the liner. The depth of the groove corresponds to the amount of radial expansion of the rotor blades 2. The gap between the tips of the fins 8, 10 and the liner is therefore limited to a size at which the rotor blades 2 do not contact with the liner. The hardness of the magnesium aluminate spinel coating, in particular the hardness of the coating at the elevated temperatures, means that the coating is extremely hard wearing during engine operation and so is resistant to degradation over prolonged periods of time. Consequently, the thickness of the coating is maintained over a longer period of time thereby maintaining the gap between the tips of the fins 12, 14 and the abradable liner and so minimises fin tip losses for a longer period than conventional coatings. Consequently, the performance, for example specific fuel consumption, of the turbine over the lifetime of the engine is improved and maintenance of the turbine is required less frequently.

The wear-resistant coating also improves the robustness of the rotor blades making them more resistant to damage during handling.

It will be appreciated that a wear-resistant coating comprising magnesium aluminate spinel could be used at the tips of shroudless turbine blades; for example at the ends of an aerofoil section of a shroudless blade, or on fins provided at the tip of a shroudless blade. In addition, a wear-resistant coating comprising magnesium aluminate spinel could be provided on other regions of a rotor blade, particularly regions subjected to high operating temperatures at which wear resistance is required (e.g. blade root fixings), or other types of rotor blades such as compressor blades and fan blades.

A wear-resistant coating comprising magnesium aluminate spinel could be applied to blades having existing coatings, for example during maintenance of an engine, to provide a multi-layer coating.

1. A rotor blade for a gas turbine engine, comprising a blade tip, at least a portion of the blade tip being provided with a wear-resistant coating comprising magnesium aluminate spinel.

2. A rotor blade as claimed in claim 1, wherein the wear-resistant coating is an abrasive coating.

3. A rotor blade as claimed in claim 1, wherein the wear-resistant coating is an external coating.

4. A rotor blade as claimed in claim 1, wherein the wear-resistant coating is a continuous coating.

5. A rotor blade as claimed in claim 1, wherein a bond coating is disposed between the wear-resistant coating and a substrate material of the rotor blade for bonding the wear-resistant coating to the substrate material.

6. A rotor blade as claimed in claim 1, wherein the blade tip is provided with a fin extending outwardly of the blade tip in the spanwise direction of the blade, the wear-resistant coating being provided on the fin.

7. A rotor blade as claimed in claim 6, wherein the blade tip comprises a shroud, the fin being provided on the shroud.

8. A rotor blade as claimed in claim 1, which is a turbine blade.

9. A gas turbine engine comprising a casing and a rotor rotatable within the casing, the rotor carrying a plurality of rotor blades, at least one of the rotor blades being in accordance with any one of the preceding claims, wherein the casing comprises an abradable liner, the rotor blade being arranged such that rotation of the rotor with respect to the casing causes the portion of the blade tip having the wear-resistant coating to rub against the liner.

10. A method of coating a tip of a rotor blade for a gas turbine engine, wherein a wear-resistant coating comprising magnesium aluminate spine! is applied to at least a portion of the tip using a thermal spraying process.

11. A method as claimed in claim 10, wherein the thermal spraying process comprises a plasma spraying process or a high velocity oxygen fuel spraying process.

12. A wear-resistant coating comprising magnesium aluminate spinel.

13. (canceled)

14. (canceled)
